(19) United States
(12) Patent Application Publication
(10) Pub. No.: US 2011/0011931 A1
(43) Pub. Date: Jan. 20, 2011

(54) One-Card Transaction Management System

(75) Inventors: Pierre Farley, Ste-Marie-Salome (CA); Marcel Vienneau, Montreal (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Fidelisoft Inc., Montreal (CA)

(21) Appl. No.: 12/503,032

(22) Filed: Jul. 14, 2009

(51) Int. Cl. G06K 7/01; G06Q 30/00; G06Q 50/00

(52) U.S. Cl. 235/382.5; 705/17; 235/379; 235/380

(57) ABSTRACT

A transaction management system enabling a user to perform a transaction using a neutral card at a point-of-sale unit in communication with a central server via a system network is provided. The system includes a terminal application at the point-of-sale unit and a data storage module connected to the central server, having a user profile corresponding to the neutral card. The user profile is linked to a plurality of transaction accounts and defines one or more specification for each transaction account linked thereto, each specification being associated to a weight. The system further including a server application at the central server for associating the card information to the corresponding user profile, generating one or more transaction scenario based on the transaction data and the weight of each specification of each transaction account linked to the user profile, and transmitting the transaction scenario(s) to the point-of-sale unit.

### FIELD OF THE INVENTION

The present invention relates to the field of electronic transactions and more particularly concerns a transaction management system allowing a user to perform a transaction using a neutral card at a point-of-sale and capable of generating transaction scenarios based on this neutral card, as well as to a method associated thereto.

### BACKGROUND OF THE INVENTION

Electronic transaction systems are well known in the art. Conventional electronic transaction systems generally allow a user to perform a transaction at a merchant site by using one or more cards, each of which are linked to a corresponding account. The purchaser chooses the account which he or she wishes to use (for example credit card or debit card) to complete a transaction. Additional account cards may be required for obtaining advantages such as loyalty points which are applicable to the merchant site. Thus the purchaser and/or user is required to manipulate a number of cards and is burdened with the task of evaluating which card and/or combination thereof is most advantageous for him or her, within some constraints, for example, cards accepted at the merchant, which may not be fully known to or understood by the purchaser.

Multiple card management systems are disclosed in U.S. Pat. No. 5,578,808 issued to TAYLOR on Nov. 26, 1996, no. 6,000,608 issued to DORF on Dec. 14, 1999, U.S. Pat. No. 6,494,367 issued to ZACHARIAS on Dec. 17, 2002, and no. 6,886,741 issued to SALVESON on May 3 2005, and in US Patent Applications no. 2004/0010462 in the name of MOON et al. published on Jan. 15, 2004, no. 2003/0155416 in the name of MACKLIN et al. published on Aug. 21, 2003 and no. WO 2004/008288 in the name of MOON et al. published on Jan. 22, 2004. These teachings however suffer from drawbacks. Indeed and for example, the above-mentioned systems of the prior art require that the user evaluates different possibilities (i.e. compares advantages and calculates points, amounts, interest, etc.) at the time of a transaction so as to determine which account to use for completing the transaction.

Another multiple card management system is disclosed in US patent application no. 2005/0097039 in the name of KULCSAR et al. published on May 5 2005. KULCSAR discloses a system allowing the management of several client accounts including debit, credit, checking and various other accounts related to entertainment or other financial services. The system allows for the use of a single card to initiate a transaction request and, based on predetermined criteria set by the user, the transaction is completed using the transaction account which provides the most advantages to the user. However, the predetermined criteria for evaluating the most advantageous transaction account, does not factor certain parameters which may vary depending on the merchant, amount of transaction, insurance coverage, etc. which could impact the advantages provided to the user for a particular transaction and thus the choice of transaction account or transaction accounts to be used.

Thus, in light of the aforementioned, there is a need for an improved transaction system which, by virtue of its design and components, would be able to overcome some of the above-discussed prior art concerns.

### SUMMARY OF THE INVENTION

Embodiments of the present invention advantageously provide a system which, by virtue of its design and components, satisfies some of the above-mentioned needs and is thus an improvement over other related multiple account transaction systems and/or methods known in the prior art.

In accordance with one aspect of the present invention, there is provided a transaction management system for enabling a user to perform a transaction using a neutral card at a point-of-sale unit in communication with a central server via a system network, the neutral card bearing card information. The system first includes a terminal application at the point-of-sale unit for inputting the card information, inputting transaction data related to the transaction, forwarding the card information and transaction data to the central server, receiving at least one transaction scenario from the central server, presenting the at least one transaction scenario to the user, inputting a user selection of one of the at least one transaction scenario, thereby defining a selected scenario, and forwarding the selected scenario to the central server for completing the transaction based thereon.

The system further includes a data storage module connected to the central server and including a user profile corresponding to the neutral card. The user profile is linked to a plurality of transaction accounts, the user profile having at least one specification for each transaction account linked thereto, each specification being associated to a weight.

The system also includes a server application at the central server for associating the card information to the corresponding user profile, generating the at least one transaction scenario based on the transaction data and the weight of each specification of each transaction account linked to the user profile, and transmitting the at least one transaction scenario to the point-of-sale unit.

According to another aspect of the present invention, there is provided a method for enabling a user to complete a transaction using a neutral card with the above-mentioned transaction management system.

The method includes a step, at a point-of-sale, of inputting card information related to the neutral card and transaction data related to the transaction, and forwarding the card information and transaction data to a central server.

The method further includes a step, at the central server, of associating the card information to a user profile corresponding to the neutral card, the user profile being linked to a plurality of transaction accounts, the user profile having at least one specification for each transaction account linked thereto, each specification being associated to a weight.

The method further includes a step, also at the central server, of generating at least one transaction scenario based on the transaction data and the weight of each specification of each transaction account linked to the user profile, and transmitting the at least one transaction scenario to the point-of-sale unit.

The method further includes a step, at the point-of-sale, of obtaining a user selection of one of the at least one scenario, thereby defining a selected scenario, and forwarding the selected scenario to the central server.

The method further includes a step of completing the transaction based on the selected scenario.

The advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a functional block diagram of the method according to one embodiment of the present invention.

FIG. 2 is a diagram representing relationships between a neutral card, transaction accounts, specifications and weights, according to an embodiment of the present invention.

FIG. 3 is a sequence diagram representing the sequence of steps relating to a method of using the transaction management system, according to one embodiment of the present invention.

FIG. 4 is a diagram representing relationships between transaction scenarios, transactional operations, scenario weight values and transaction accounts, according to an embodiment of the present invention.

FIG. 5 is a functional block diagram of the transaction management system according to one embodiment of the present invention.

FIG. 6a is a perspective view of a point-of-sale unit according to an embodiment of the present invention.

FIG. 6b is a perspective view of a point-of-sale unit according to another embodiment of the present invention.

FIG. 6c is a perspective view of a point-of-sale unit according to yet another embodiment of the present invention.

FIG. 7 is a functional block diagram of the point-of-sale unit according to an embodiment of the present invention.

FIG. 8 is a functional block diagram showing a part of the transaction management system according to an embodiment of the present invention.

FIG. 9 is a functional block diagram showing another part of the transaction management system according to an embodiment of the present invention.

FIG. 10 is a functional block diagram showing a central server of the transaction management system according to an embodiment of the present invention, in connection with authorization hosts.

### DETAILED DESCRIPTION

In the following description, the same numerical references refer to similar elements. The embodiments, configurations, and/or components shown in the figures or described in the present description are preferred embodiments only, given for exemplification purposes only.

In addition, although the preferred embodiment of the present invention as illustrated in the accompanying drawings comprises components such as a point-of-sale unit, a payment terminal, a card reader, a keypad, etc., and although the described embodiments of the transaction management system and corresponding elements thereof consist of certain configurations as explained and illustrated herein, not all of these components and configurations are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable configurations may be used for the transaction management system according to the present invention, as will be briefly explained herein and as can be easily inferred herefrom, by a person skilled in the art, without departing from the scope of the invention.

Broadly described, the transaction management system according to embodiments of the present invention, as exemplified in the accompanying drawings, provides a transaction system and a method allowing a user to perform a transaction involving one or more transaction accounts and this by using a single card, hereinafter also referred to as the “neutral card”, at a point-of-sale unit, thus avoiding the need to manipulate more than one account card, and further allowing the user to select a most advantageous transactional operation or combination thereof.

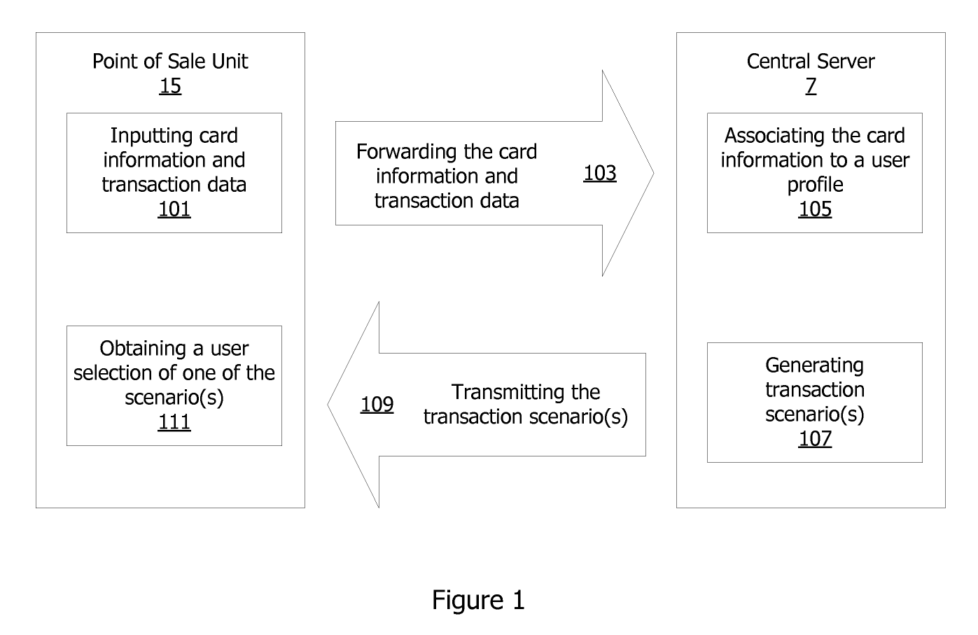

According to an embodiment of the present invention, and as better illustrated in the accompanying drawings, namely with reference to FIGS. 1, 2 and 3, there is provided a method for enabling a user 3 to complete a transaction using a neutral card 5.

The method includes a step 101 of, at a point-of-sale unit 15, inputting card information 11 related to the neutral card 5 and transaction data 17 related to the transaction, and a step 103 of forwarding the card information 11 and the transaction data 17 from the point-of-sale unit 15 to a central server 7.

The method further includes a step 105 of, at the central server 7, associating the card information 11 to a user profile 25 corresponding to the neutral card 5, the user profile 25 being linked to transaction accounts 27. The user profile 25 has at least one specification 29 for each transaction account 27 linked thereto, each specification 29 being associated to a weight 31.

The method further includes a step 107 of, also at the central server 7, generating one or more transaction scenario(s) 19 based on the transaction data 17 and the weight 31 of each specification 29 of each transaction account 27 linked to the user profile 25, and a step 109 of transmitting the transaction scenario(s) 19 from the central server 7 to the point-of-sale unit 15.

The method further includes a step 111, at the point-of-sale 15, of obtaining a user selection of one of the transaction scenario(s) 19, preferably selected by the user, thereby defining a selected scenario 21, and a step 113 of forwarding the selected scenario 21 from the point-of-sale unit 15 to the central server 7.

The method further includes a step of completing the transaction based on the selected scenario 21.

In accordance with embodiments of the present invention, the card information 11 associated to the neutral card 5 may include a unique identification code, such as a bank account number, card number and/or any other account information, and an authentication code associated with the neutral card 5, such as PIN (personal identification number), a password, fingerprint data, voice authentication data, retinal authentication data and/or any other suitable form of data. Preferably, the authentication code is associated to the all transaction accounts 27 linked to the user profile 25. Alternatively, other identification codes and/or authentication codes may be included in the card information 11, so as to distinguish each transaction account 27 or group thereof, linked to the user profile 25, as can be easily understood by a person skilled in the art.

Preferably, the transaction data 17 comprises an amount, a transaction type (e.g., payment, reimbursement, point redemption, etc.), transaction account data, point-of-sale data, and/or the like. For example, where a transaction consists in a payment via a credit card account at a particular merchant site, the transaction data 17 may include the amount of the payment, the transaction type being a “payment”, information on the credit card account, such as data referring to an associated points program, etc. and point-of-sale data such as a list of acceptable payment method by the particular merchant, a reward program associated to the merchant, an identification code associated to the merchant and/or any other information based on the merchant and/or point-of-sale equipment.

Moreover, each specification 29 associated to an account 27 may be an interest rate, a loyalty value, a loyalty value percentage, an insurance coverage, a warranty value, an account balance, an account limit, a user preference (e.g., preference of a particular account over another, user specified account limit, preference of a type of reward earning over another, preference of an account based on merchant or transaction amount, etc.), and/or the like. Preferably, the weight of each specification is a value based on at least one factor such as the corresponding specification 29, the selected scenario 21 (and thus the corresponding transactional operation 67), the transaction account 27 associated to the specification 29, the point-of sale unit 15 and/or any other suitable factors for evaluating the advantage level of a transaction scenario 19. Indeed, the weight 31 of each specification 29 may be used to generate, compare and/or sort the various transaction scenarios 19 and allow the user to execute a transaction in a most advantageous manner.

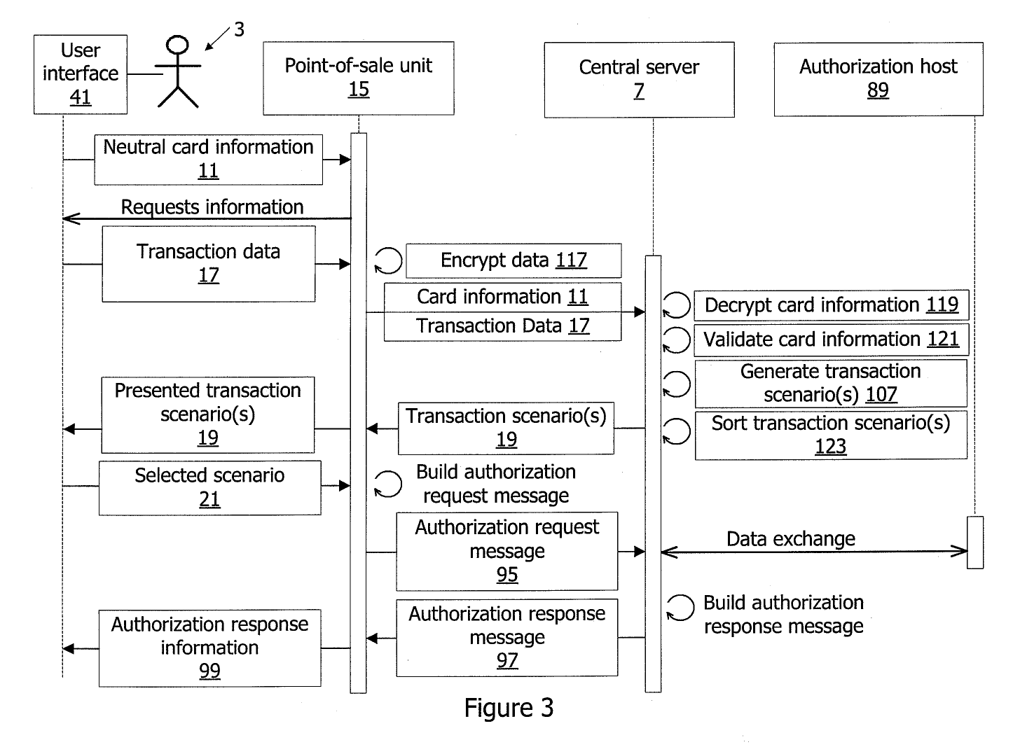

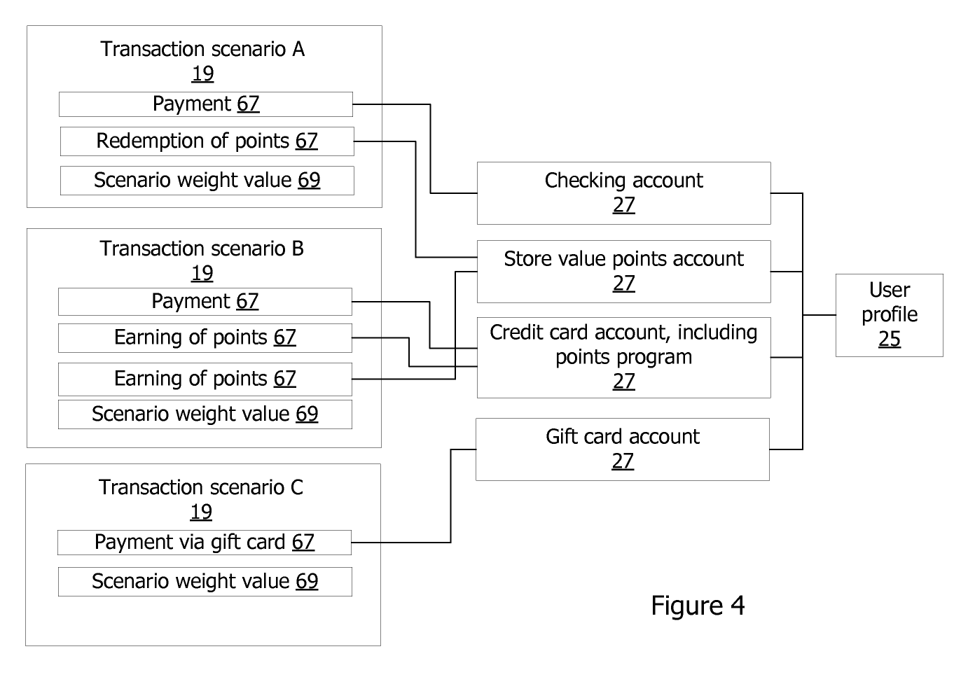

Preferably, referring now to FIGS. 3 and 4 of the drawings, each of the transaction scenarios 19 is a suggested transaction, each transaction scenario 19 including one or more transactional operation(s) 67 for debiting from or crediting one of the transaction accounts 27 associated with the user profile 25. A transactional operation 67 may be, for example, a payment, a reimbursement, a loyalty value earning, a loyalty value redemption, a credit value, an insurance coverage, an insurance claim, a discount, a service earning, an article earning, etc., and/or any combination thereof. Each transaction account 27 may be any one of a credit card account, a debit card account, a loyalty card account, a discount card account, a token card account, a store value card account, an insurance account, a running bill account, a gift card account, a prepaid card account, and/or any other entertainment or service related account such as a movie card, a cellular telephone card, a long distance cellular phone card, etc., and/or the like. Moreover, the transaction account 27 is not necessary associated to a card, as can be easily understood by a person skilled in the art. Indeed and for example, the account may be accessible via a web application using suitable identification data. The user may thus choose one transaction scenario 19 as a selected scenario 21 so as to prompt the corresponding transactional operation(s) 67 to be completed. Indeed and as exemplified in FIG. 4, a first transaction scenario 19 presented to the user may refer to a payment using a checking account and redemption of store value points from a corresponding store value account, a second transaction scenario 19 may include the payment by credit card including the earning of reward points related to the credit card account as well as an additional earning of loyalty points to a corresponding loyalty point account, and a third transaction scenario 19 may include the payment using a gift card. In the afore-mentioned example, the user would be prompted to select one of the presented transaction scenarios 19 to complete the transaction.

Referring now to FIG. 3, the method according to a preferred embodiment of the present invention, further includes, prior to forwarding 103 the card information 11 and transaction data 17 to the central server 7, a step 117 wherein the point-of-sale unit 15 encrypts at least a portion of the card information 11 and transaction data 17 and further includes, prior to associating 105 the card information 11 to a user profile 25, a step 119 wherein the central server 7 decrypts the portion of the card information 11 and transaction data 17. Indeed and for example, it may be desirable to protect sensitive data such as a user's account number, amount of the transaction, PIN number, accounts being used, etc.

Preferably, the method further includes, prior to generating transaction scenario(s) 107, a step 121 wherein the central server 7 validates at least a portion of the card information and transaction data.

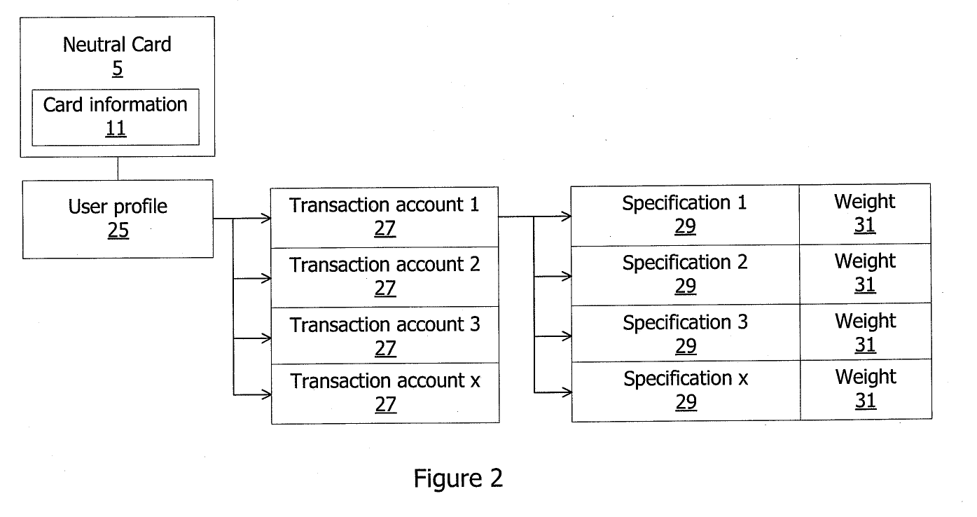

Referring now to FIGS. 2, 3 and 4, the method further includes a step 123 of sorting transaction scenario(s) 19, such that the central server 7 generates the transaction scenario(s) 19 in a sorted order according a scenario weight value 69. Preferably, the scenario weight value 69 is a monetary value, a point value, an interest rate value and/or a monetary equivalent value, based the weight 31 corresponding to each specification 29. Moreover, the scenario weight value 69 may be calculated based on quantifiable data related to each weight 31 of the specification(s) 29 of a transaction account 27 involved in the transaction scenario 19. Preferably, the total weight value 69 is the average of weights 31. Alternatively, the total weight. Such a quantifiable data may include, for example, a monetary value, a point value, an interest rate value, a monetary equivalent value, a loyalty percentage, a loyalty value, and or the like. Thus, a scenario weight value 69 may be assigned to each transaction scenario 19 so as to provide a basis of comparison between the different transaction scenarios 19, and thus allowing to present the transaction scenarios 19 to the user 3 in a sorted manner at the point-of-sale unit 15.

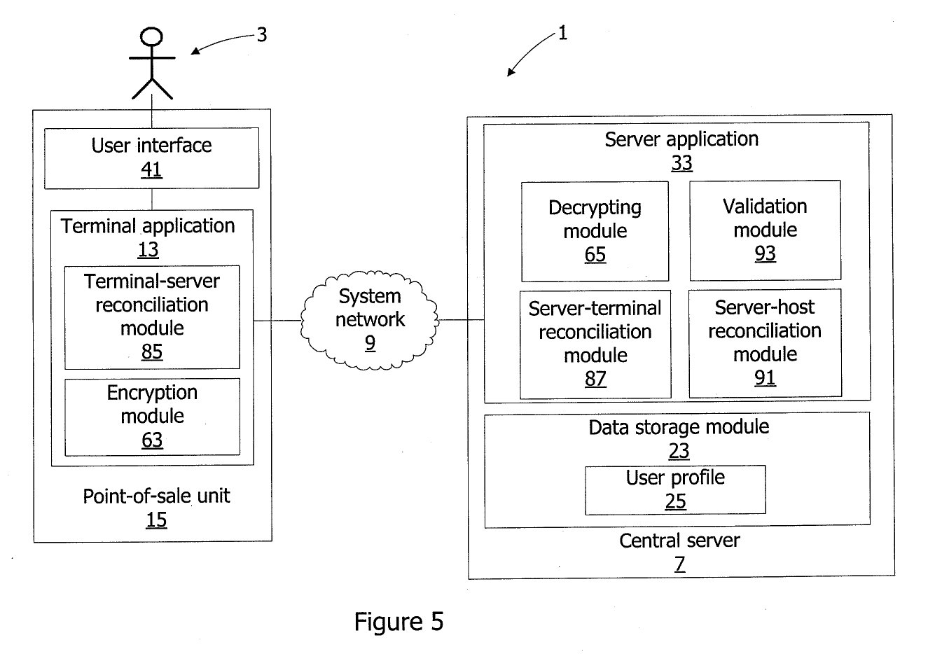

Referring now to FIG. 5, there is shown a transaction management system 1 according to an embodiment of the present invention enables a user 3 to perform a transaction using a neutral card 5 at a point-of-sale unit 15 which is in communication with a central server 7 via a system network 9, the neutral card 5 bearing card information 11.

The system 1 first includes a terminal application 13 at the point-of-sale unit 15 for inputting the card information 11, for inputting transaction data 17 related to the transaction, for forwarding the card information 11 and transaction data 17 to the central server 7, for receiving at least one transaction scenario 19 from the central server 7, for presenting the at least one transaction scenario 19 to the user, for inputting a user selection of one of the at least one transaction scenario 19, thereby defining a selected scenario 21, and for forwarding the selected scenario 21 to the central server 7 to complete the transaction based thereon.

The system 1 further includes a data storage module 23 connected to the central server 7, which includes a user profile 25 corresponding to the neutral card 5, the user profile 25 being linked to a plurality of transaction accounts 27, the user profile 25 having at least one specification 29 for each transaction account 27 linked thereto, each specification 29 being associated to a weight 31.

The system 1 further includes a server application 33 at the central server 7 for associating the card information 11 to the corresponding user profile 25, for generating the at least one transaction scenario 19 based on the transaction data 17 and the weight 31 of each specification 29 of each transaction account 27 linked to the user profile 25, and for transmitting the at least one transaction scenario 19 to the point-of-sale unit 15.

Preferably, the terminal application 13 includes an encryption module 63 for encrypting at least a portion of the transaction data 17 and the selected scenario 21, prior to forwarding the data to the central server. Preferably, the server application 33 further includes a decrypting module 65 for decrypting the encrypted data. Preferably, the server application 33 also includes a validation module 93 for validating card information 11 and/or transaction data 17 received from the point-of-sale unit 15.

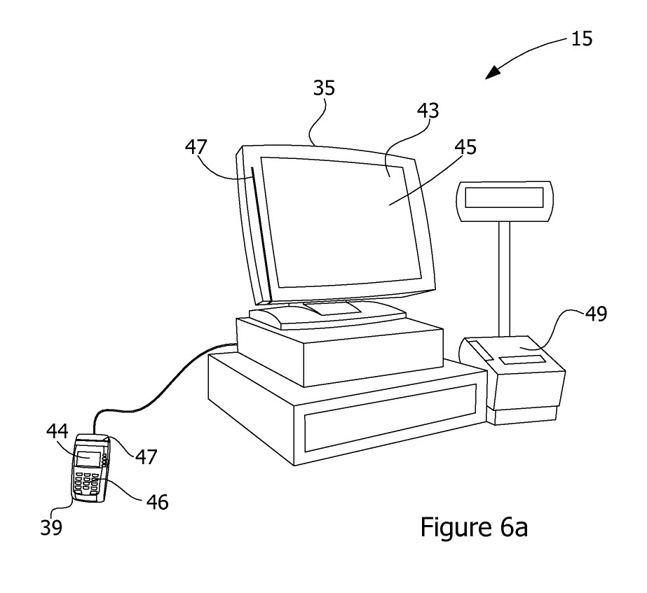

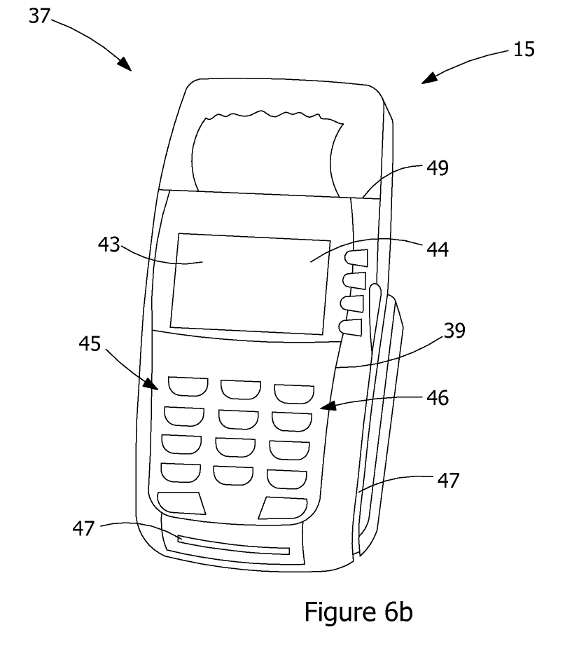

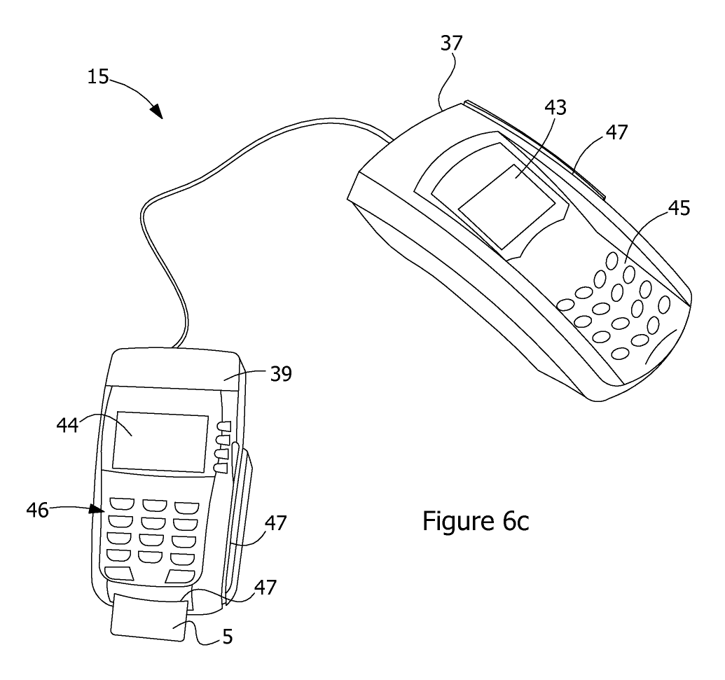

Referring now to FIGS. 6a to 6c of the drawings, and as known in the art, the point-of-sale unit 15 may include any point-of-sale equipment such as an integrated cash register 35, a payment terminal 37, a PINpad 39, a conventional computer, a mobile device, etc. and/or a combination thereof. The PINpad 39 may be the point-of-sale unit 15 or may cooperate with one or more other point-of-sale equipment via a cable network, a wireless network, and/or any other suitable form of communication. Preferably, the point-of-sale unit 15 includes a user interface 41 (see FIG. 5) for allowing a user to interact with the point-of-sale unit, for example, for entering data such as user authentication information when completing a transaction and/or the like. The user interface may include a terminal screen 43, a terminal keypad (for example, a touch screen) 45, a card reader 47, a printer 49, or any other peripheral equipment such as a microphone (not illustrated), a speaker (not illustrated), a scanner (not illustrated), a RFID transceiver (not illustrated), and/or the like. For example, the speaker may allow a visually impaired or illiterate user to interact with the transaction management system according to an embodiment of the present invention. Moreover, the PINpad 39 may also include user interface components such as for example, a PINpad screen 44, a PINpad keypad 46, a card reader 47, a printer 49 and/or the like.

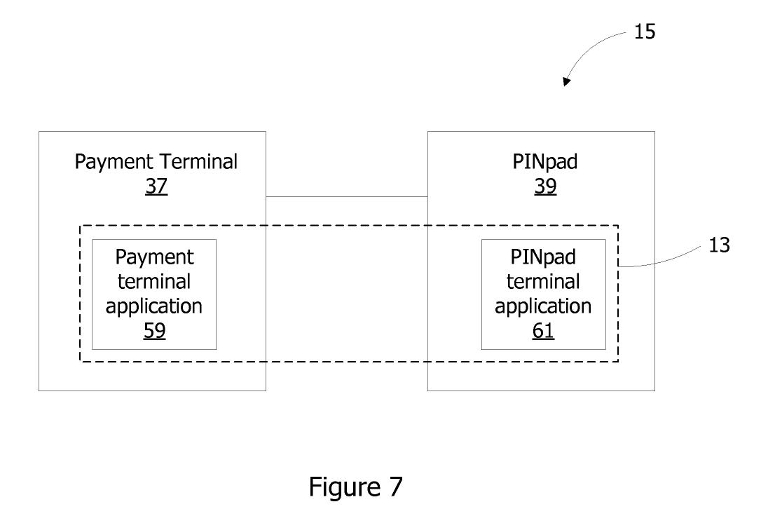

Referring now to FIG. 7 of the drawings and according to a preferred embodiment of the present invention, the point-of-sale unit 15 includes more than one device, for example, a payment terminal 37 and a PINpad 39 operatively connected together. The terminal application 13 preferably comprises a payment terminal application 59 at the payment terminal 37 and/or a PINpad terminal application 61 at the PINpad 39. Indeed, the payment terminal 37 and PINpad 39 may each include an application which cooperates so as to define the terminal application 13. Alternatively, the above-mentioned device may be an integrated cash register system, a conventional computer, a mobile device, etc., any of which may or may not include the terminal application, in part or in whole.

Preferably, referring back to FIG. 3, the transaction scenario(s) 19 is presented to the user at the point-of-sale unit 15. The transaction scenario(s) 19 may be presented to the user via any user interface 41 as known in the art, such as, for example, a display screen, a touch-screen, a printed document, a speaker and/or the like (see FIGS. 6a to 6c). The selected transaction scenario 19 is preferably defined, based on the user selection, including any form of instruction received via the user interface 41, for example a contact on a touch screen, a keystroke on a PINpad or a keyboard and/or the like. The selected transaction scenario 19 is preferably forwarded to the central server 7 for completing the transaction. It is contemplated that, at the presentment of the transaction scenario(s) 19, additional information related to each transaction scenario 19 may also be presented to the user 3 so as to provide further information to the user. Indeed, information such as interest rate, number of loyalty points redeemed, monetary value of a discount, account balance, etc. may be presented to the user for each transaction scenario 19. Optionally, the information to be displayed may be configured by the user as part of a user preference of the corresponding user profile 25. Thus the user may be informed of possible transactional operation(s) 67 and corresponding parameters with respect to the intended transaction. Indeed, for example, a user may not be aware that a particular loyalty program applies to a given merchant, and will be informed accordingly as the transaction scenarios 19 are presented. Moreover, it is contemplated, according to an embodiment of the present invention, that additional information may be provided with the presentment of the various transaction scenarios 19, for example loyalty programs or accounts which the user has not registered to but which could apply for an intended transaction.

Preferably, where a plurality of transaction scenarios 19 are generated, the server application sorts the transaction scenarios 19 according to a scenario weight value 69 associated to each transaction scenarios 19, as explained in more detail below.

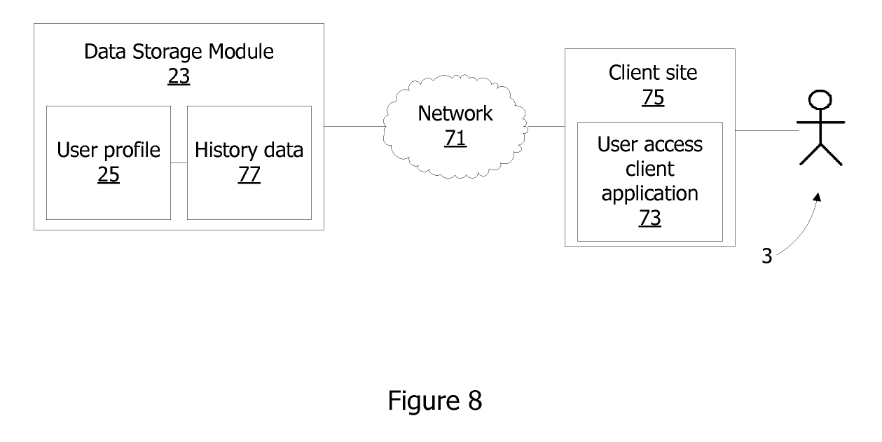

Preferably, referring now to FIG. 8 of the drawings, the data storage module 23 is connected to a telecommunication network 71, such as Internet, a wireless network, a dedicated network and/or the like, which is accessible to the user 3. Preferably, a user access client application 73, such as a web application for example, located at a client site 75 is connected to the data storage module 23 allowing a user to access and update his or her user profile 25 through the telecommunication network 71. The client site 75 may be a device such as a conventional computer, a laptop, a telephone, or a wireless device such as a cellular telephone, a handheld computer, a chip card, or even a point-of-sale equipment and/or the like. Preferably, the data storage module 23 comprises history data 77 linked to the user profile 25. The history data 77 may comprise information such as transaction history, profile history and/or the like. Alternatively, the user access client application 73 may be connected to the server application (not illustrated) which is connected to the data storage module 23. Preferably, the user access client application 73 allows the user to, with reference to FIG. 2, add or remove links from the neutral card 5 to an account. The user may also change an account linked to the user profile 25. Moreover, the user may update user preferences and/or calculation rules affecting the weight of each specification 29. Indeed and for example, a user may update his or her profile so as to favor the use of one or more particular card(s), the user profile 25 may be further updated to favor one or more cards based on merchant, merchant type, region, account balance, and/or the like. Optionally, the user may have access to each respective account data as well.

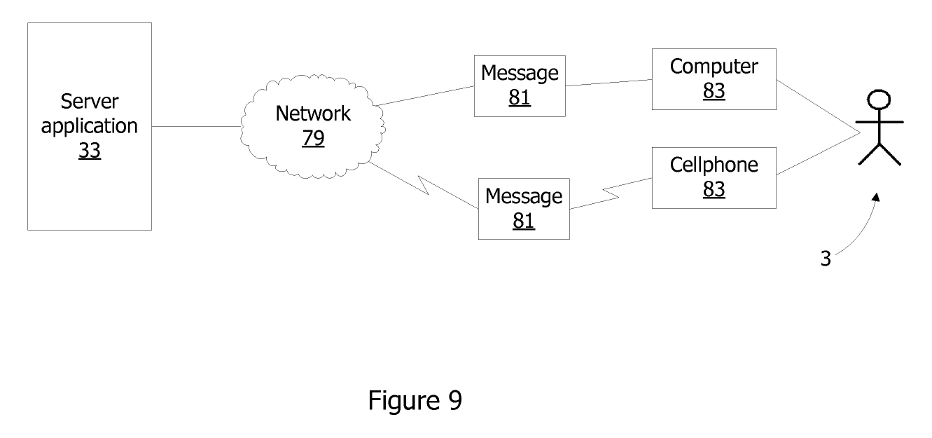

Preferably, referring now to FIG. 9 of the drawings, the server application 33 is connected to a communication network 79 for transmitting a message 81 to a remote device 83 accessible to the user when a transaction associated to the neutral card occurs or when the user profile is updated or accessed, so as to keep the user informed of any fraudulent acts with respect to his or her neutral card. The message 81 may be an e-mail, a text message, a ring tone, a sound, an image, an animation, a vibration, and/or any other signal or data communicated to alert the user and may be transmitted to any suitable remote device 83 such as for example, a conventional computer, a laptop, a telephone, a cellular phone, a handheld computer, a chip card and/or the like. Preferably, such a feature allows the user to be immediately alerted of transactions being completed with respect to any of his/her account(s). Optionally, such a message may only be transmitted when one or more condition(s) is/are satisfied. For example, an alert message may be sent only when the user's cellular phone is not in proximity of the point-of-sale unit where the transaction is initiated. Preferably, such conditions may be customized via the user profile.

Moreover, referring to FIG. 5, the transaction management system 1, according to the preferred embodiment of the present invention, includes a terminal-server reconciliation module 85 for reconciling the transaction data 17 between the point-of-sale unit 15 and the central server 7 which may be executed at the end of a day and/or at any other suitable time. A server-terminal reconciliation module 87 may also be provided at the server application 33 for reconciling the transaction data 17 between the central server 7 and the point-of-sale unit 15.

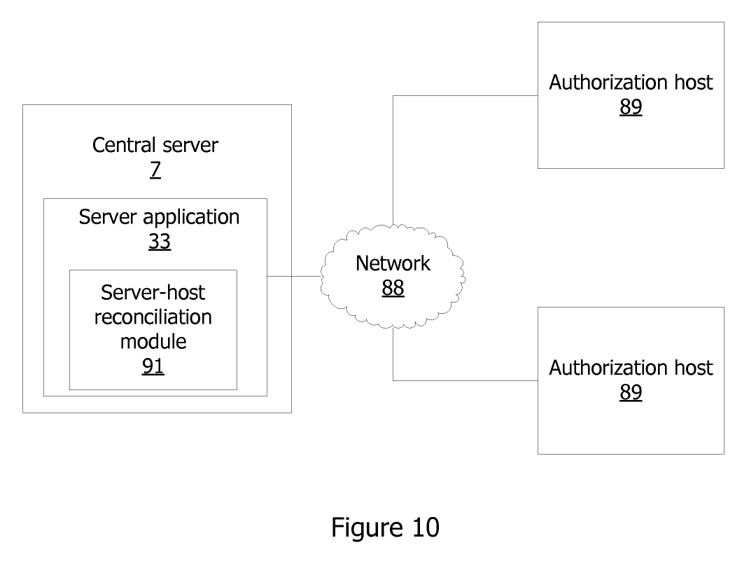

Preferably, referring now to FIG. 10, the central server 7 is in communication, via a network 88 with at least one authorization host 89 for authorizing the transaction. The server application 33 preferably comprises a server-host reconciliation module 91 for reconciling the transaction data between the central server 7 and the authorization host(s) 89.

With respect to the operational aspect of the transaction management system 1, as exemplified in FIG. 3, according to a preferred embodiment of the present invention, a transaction is preferably initiated by entering transaction data 17 such as an amount and a type of transaction, and further providing card information 11, for example, by swiping the neutral card 5 or sliding the card in a card reader 47 (see FIGS. 6a to 6c), at the point-of-sale unit 15, thus prompting a transaction request. The terminal application 13 is then triggered to build at least one query requesting the user to enter data such as authentication information (for example a PIN entered via a PINpad). The authentication information may be provided in various forms. Indeed and for example, the authentication may be provided by an additional device, for example by sending a PIN from a user's cellular telephone to the point-of-sale unit 15. Moreover, the authentication data may be provided with the input of card information 11.

Preferably, the transaction data 17 and/or the card information 11 are encrypted by the encryption module 63 at the terminal application 13 and forwarded to the server application 33 at the central server 7. Preferably, the decrypting module 65 (see FIG. 1) of the server application 33 then decrypts the data and a validation module 93 (see FIG. 5) of the server application 33 validates the authentication information (example: PIN and/or other authentication code). Conditional to a valid authentication code, the server application 33 then generates one or more transaction scenario(s) 19.

Preferably, with reference to FIGS. 2, 3 and 4, prior to transmitting the transaction scenario(s) 19 to the point-of-sale unit 15, the server application 33 first evaluates the weight 31 of each specification 29 of each transaction account 27 associated to one of the scenarios. Optionally, the weight 31 of some of the specifications 29 may take into consideration the usage of a particular account by the user, so as to dynamically reflect and update the user's preferences (for example, number of transactions with a particular transaction account, account most often used with a particular merchant, type of transaction and/or amount of transaction, etc.), and may further combine this parameter to the merchant type, transaction amount, transaction type, etc. Alternatively, the weight of some or all of the specifications 29 may be predetermined.

Preferably, the server application 33 then calculates a scenario weight value 69 for each generated transaction scenario 19 based on the weight 31 of each corresponding specification 29. Preferably, the scenario weight value 69 of each generated transaction scenario 19 is compared so as to sort the transaction scenario(s) 19 from most advantageous to least advantageous. The factors determining most advantageous and least advantageous may depend on a number of criteria. Indeed, a combination of factors such as number of reward points, interest rate of a credit, store value, merchant promotions and/or limitations, user preferences specified in the user profile 25, balance in transaction account 27 and/or the like may be taken into consideration in the determination of the weight 31 of each specification 29 and thus for the sorting of transaction scenarios 19 from most advantageous to least advantageous, most advantageous preferably corresponding to a scenario having the highest scenario weight value 69 and least advantageous preferably corresponding to the lowest scenario weight value 69.

Preferably, following the generation of transaction scenarios 19 by the server application 33, a selected group of generated transaction scenarios 19, preferably a group of the most advantageous scenarios, are transmitted to the point-of-sale unit 15. Alternatively, the most advantageous transaction scenario 19 is transmitted to the terminal application 13 at the point-of-sale unit 15 or is automatically processed as a transaction request. Alternatively, the totality of transaction scenarios 19 may be transmitted by the server application 33 to the point-of-sale unit 15 and presented to the user in a sorted fashion from most advantageous to least advantageous, allowing the user to select the desired transaction scenario 19.

Preferably, upon reception of the transaction scenario(s) 19 provided by the server application 33, the terminal application 13 presents the transaction scenario(s) 19 to the user 3. Upon receiving a user selection, and thus a selected scenario 21, the terminal application 13 builds a corresponding authorization request message 95 for completing the transaction. Preferably, the authorization request message 95 is sent to the server application 33 at the central server 7.

Preferably, the central server 7 receives the authorization request message 95 from the point-of-sale unit 15, and the server application 33 preferably reformats the authorization request message 95, as is well known in the art, such that it is compatible with the corresponding authorization host 89 to which the authorization request message 95 is destined. Preferably, the authorization host 89 receives the data from the server application 33, processes the transactional operation corresponding to the elected scenario 21 and provides a response to the server application 33. Preferably, the authorization host 89 is external to the system according to an embodiment of the present invention. Alternatively, according to another embodiment of the present invention, the authorization host 89, or a part thereof, is integrated in the one-card transaction system. A data exchange may take place between the server application 33 and the authorization host 89 so as to allow the server application 33 to build an authorization response message 97 based on data received from the authorization host 89 in a format which is compatible with the terminal application 13 at the point-of-sale unit 15. The server application 33 transmits the authorization response message 97 to the terminal application 13 which in turn provides authorization response information 99 to the user 3 via the user interface 41. The authorization response information 99 is based on the authorization response message 97 and may include a confirmation of the completion of the transactional operation, a refusal of the transactional operation, a personalized message for the user, a receipt printed via the printer, and/or any other relevant information related to the transaction and/or user account. More than one authorization hosts 89 may interact with the server application 33 of the central server 7 for a single transaction as can be easily understood by a person skilled in the art. For example, the selected scenario 21 may comprise a payment by credit card and the awarding of store value points, in which case a first data exchange takes place between the central server 7 and the corresponding bank, another exchange may take place between central server 7 and a loyalty points provider associated with the credit card and a third exchange may take place between the central server 7 and the store value provider. Accordingly, the authorization response message 97 may include information related to all concerned authorization hosts 89.

In the present context, it will be understood by one skilled in the art that the term “user” refers to any person or system interacting with the point-of-sale unit in the course of a transaction. Typically, the user may be a merchant clerk, a customer present or remote from the point-of-sale unit, or any other appropriate person. Indeed, for completing a transaction at a point-of-sale unit, both the merchant clerk and the customer are generally involved in exchanging information with the point-of-sale unit and will therefore collectively define the “user” understood herein.

Moreover, in the context of the present invention, the term “neutral card” refers to any portable article suitable for cooperating with a point-of-sale unit to initiate an electronic transaction and typically includes articles in the form of a smart card, a chip card, an integrated circuit card, a microprocessor card, a magnetic stripe card, but may also include any other type of electronic payment tool or device such as, for example, a cellular telephone, a portable computer and/or the like. Alternatively, still in the context of the present invention, the “neutral card” may refer to identification data, such as a login code and/or password which may be used in order to complete a transaction over the Internet. The neutral card 5 bears card information which may be useful to a transaction as will be better described further below.

Moreover, in the context of the present invention, the term “point-of-sale unit” refers to any suitable device which allows the processing of a transaction, such as, for example, a conventional cash register, a transaction terminal, a PINPAD, an integrated cash register system, or even a computer, a laptop, a mobile phone, a wireless communication device and/or the like as can be easily understood by a person skilled in the art. The point-of-sale unit may be located at a commercial site, such as a store or any merchant's facility. Alternatively, the point-of-sale unit may be located in a home, an office, in the form of a computer or any personal electronic device. Moreover, the point-of-sale unit may also be any suitable mobile device, as previously mentioned, and is thus not necessarily permanently located at a particular location.

Moreover, in the context of the present invention, the term “central server” refers to any conventional computer server or group thereof connected by any type of data communication means, such as cable, wireless connection, etc., within any communications network such as a LAN, a WAN, etc. For this reason, the expression “central server” should not be taken as to limit the scope of the present invention and includes any other kind and combination of suitable data processing device and network thereof with which the present invention may be used and could be useful.

Furthermore, in the context of the present invention, the term “network” refers to any connection providing communication, including, for example, a cable network, a wireless connection, a LAN, a WAN, a telephone network, a computer network and/or the like, which may be used with a communication medium such as for example, a radio wave or infrared signal transmission, etc. for communicating data.

Moreover, in the context of the present invention, the term “host” or “authorization host” refers to any entity which can authorize a transactional operation with an account, such as for example, a bank, a loyalty card issuer, any transaction card issuer, etc.

Embodiments of the present invention are particularly advantageous in that the above-described transaction management system allows for the user to complete a transaction in a most advantageous way according to the user's preference(s). The above described embodiments further avoid the need for manipulating a number of different cards.

Embodiments of the present invention provide numerous other advantages over the prior art in that a user may define his or her profile preferences and thus customize features, such as, for example, the sorting criteria of transaction scenarios.

Moreover, though the above-described embodiments are typically directed to a payment at a merchant site, embodiments of the present invention may be adapted for other electronic transaction system such as for example, public transit ticketing systems, telephone card systems, library card systems, insurance systems, etc.

Numerous modifications could be made to the above-described embodiments without departing from the scope of the present invention. Indeed and for example, the data storage module may be integrated within the central server or external thereto and accessible via communications means, as can be easily understood by a person skilled in the art. Moreover, the above-mentioned server network, telecommunication network and/or communication network may be, at least in part, the same network.

Of course, numerous other modifications could be made to the above-described and exemplified embodiments without departing from the scope of the present invention. Indeed, the above-described embodiments are considered in all respects only as illustrative and not restrictive, and the present application is intended to cover any adaptations or variations thereof, as apparent to a person skilled in the art.

What is claimed is:

1. A transaction management system for enabling a user to perform a transaction using a neutral card at a point-of-sale unit in communication with a central server via a system network, the neutral card bearing card information, the system comprising:
a terminal application at the point-of-sale unit for inputting said card information, inputting transaction data related to said transaction, forwarding said card information and transaction data to the central server, receiving at least one transaction scenario from the central server, presenting said at least one transaction scenario to the user, inputting a user selection of one of the at least one transaction scenario, thereby defining a selected scenario, and forwarding said selected scenario to the central server for completing the transaction based thereon;
a data storage module connected to said central server and comprising a user profile corresponding to said neutral card, the user profile being linked to a plurality of transaction accounts, the user profile comprising at least one specification for each transaction account linked thereto, each specification being associated to a weight; and
a server application at the central server for associating the card information to the corresponding user profile, generating the at least one transaction scenario based on the transaction data and the weight of each specification of each transaction account linked to the user profile, and transmitting the at least one transaction scenario to the point-of-sale unit.

2. The transaction management system according to claim 1, wherein the point-of-sale unit comprises at least one point-of-sale device, which is selected from the group consisting of a payment terminal, a PINpad, a cash register, an integrated cash register system, a computer and a mobile phone.

3. The transaction management system according to claim 2, wherein the terminal application is distributed on at least one point-of-sale device.

4. The transaction management system according to claim 1, wherein the card information comprises at least one of a unique identification code and an authentication code associated with the neutral card.

5. The transaction management system according to claim 4, wherein the authentication code is at least one of a PIN, a password, fingerprint data, voice authentication data and retinal authentication data.

6. The transaction management system according to claim 4, wherein the authentication code is associated with said transaction accounts linked to the user profile.

7. The transaction management system according to claim 1, wherein the transaction data comprises at least one of an amount, a transaction type, transaction account data and point-of-sale data.

8. The transaction management system according to claim 1, wherein at least a portion of the card information, the transaction data and the selected scenario forwarded to the central server is encrypted.

9. The transaction management system according to claim 1, wherein the server application comprises a validation server module for validating at least a portion of the card information and transaction data.

10. The transaction management system according to claim 1, wherein each of the at least one transaction scenario comprises at least one transactional operation for debiting from or crediting to one of the transaction accounts associated with the user profile, the transactional operations being selected from a group consisting of a payment, a reimbursement, a loyalty value earning, a loyalty value redemption, a credit value, an insurance coverage, an insurance claim and a discount.

11. The transaction management system according to claim 1, wherein each of said transaction accounts is selected from the group consisting of a credit card account, a debit card account, a loyalty card account, a discount card account, a token card account, a store value card account, an insurance account, a running bill account, a gift card account and a pre-paid card account.

12. The transaction management system according to claim 1, wherein the specification is selected from the group consisting of a loyalty value percentage, an interest rate, a loyalty value, an insurance coverage, a warranty, an account balance, an account limit and a user preference.

13. The transaction management system according to claim 1, wherein the weight is a value based on at least one factor selected from the group consisting of the point-of-sale unit, one of the at least one specification of the user profile, the selected scenario and one of the transaction accounts.

14. The transaction management system according to claim 1, further comprising a plurality of said transaction scenarios, wherein the presenting of said transaction scenarios to the user by the point-of-sale unit comprises sorting said transaction scenarios according to a scenario weight value associated with each transaction scenario.

15. The transaction management system according to claim 14, wherein the scenario weight value is based on at least one of a monetary value, a point value, an interest rate value, a monetary equivalent value, a loyalty percentage and a loyalty value.

16. The transaction management system according to claim 14, wherein the scenario weight value is calculated on the basis of the weight of each specification of each transaction account associated to the transaction scenario.

17. The transaction management system according to claim 1, wherein the data storage module is connected to a telecommunication network accessible to the user.

18. The transaction management system according to claim 17, further comprising a user access application at the central server allowing a user to update said user profile through the telecommunication network.

19. The transaction management system according to claim 1, wherein the data storage module comprises history data linked to the user profile.

20. The transaction management system according to claim 1, wherein the server application is connected to a communication network for transmitting a message to a remote device accessible to the user when a transaction associated to the neutral card occurs or when the user profile is updated.

21. The transaction management system according to claim 20, wherein the message is at least one of an email, a text message, a ring tone, a sound, an image, an animation and a vibration.

22. The transaction management system according to claim 1, wherein the terminal application comprises a terminal-server reconciliation module for reconciling the transaction data between the point-of-sale unit and the central server.

23. The transaction management system according to claim 1, wherein the server application comprises a server-terminal reconciliation module for reconciling the transaction data between the central server and the point-of-sale unit.

24. The transaction management system according to claim 1, wherein the central server is in communication with at least one authorization host for authorizing the transaction.

25. The transaction management system according to claim 24, wherein the server application comprises a server-host reconciliation module for reconciling the transaction data between the central server and the at least one authorization host.

26. A method for enabling a user to complete a transaction using a neutral card, the method comprising:
a) at a point-of-sale, inputting card information related to said neutral card and transaction data related to said transaction, and forwarding said card information and transaction data to a central server;
b) at the central server:
i) associating the card information to a user profile corresponding to said neutral card, the user profile being linked to a plurality of transaction accounts, the user profile comprising at least one specification for each transaction account linked thereto, each specification being associated to a weight;
ii) generating at least one transaction scenario based on the transaction data and the weight of each specification of each transaction account linked to the user profile, and transmitting the at least one transaction scenario to the point-of-sale unit;
c) at the point-of-sale, obtaining a user selection of one of the at least one transaction scenario, thereby defining a selected scenario, and forwarding said selected scenario to the central server;
d) completing the transaction based on the selected scenario.

27. The method for enabling a user to complete a transaction according to claim 26, wherein, at step a), the point-of-sale unit encrypts at least a portion of said card information and transaction data prior to forwarding to the central server and, prior to step b) i), the central server decrypts the portion of said card information and transaction data.

28. The method for enabling a user to complete a transaction according to claim 26, wherein, prior to step b) ii), the central server validates at least a portion of the card information and transaction data.

29. The method for enabling a user to complete a transaction according to claim 26, wherein, at step b) ii), the central server generates the at least one transaction scenario in a sorted order according a scenario weight value.

30. The method for enabling a user to complete a transaction according to claim 26, wherein the scenario weight value is at least one of a monetary value, a point value, an interest rate value, a monetary equivalent value, based the weight corresponding to each specification.
